(19) United States
(12) Patent Application Publication
(10) Pub. No.: US 2009/0201130 A1
(43) Pub. Date: Aug. 13, 2009

(54) RFID TAG WITH USER-CONTROLLED KILL MECHANISM

(75) Inventors: Kenneth L. Greenlee, Raleigh, NC (US); Christian Lee Hunt, Cary, NC (US); Anne Irene Ryan, Durham, NC (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/027,306

(22) Filed: Feb. 7, 2008

(51) Int. Cl. H04Q 5/22

(52) U.S. Cl. 340/10.1

(57) ABSTRACT

An inexpensive disabling or kill mechanism is provided for an RFID tag to allow a user to decide when to disable the tag and to initiate the kill process. RFID tag antenna circuitry is partially or wholly covered with an oxidation-retardant coating. The activation-retardant coating includes a grippable pull tab. When a user decides he or she no longer wants a functional RFID tag, the user can use the pull tab to remove the least a selectable area of the oxidation-retardant coating. Removing the selectable area will expose at least part of the antenna to begin an oxidizing process that will eventually disable the antenna. An oxidizing agent may be deposited on the antenna before the oxidation-retardant coating is put in place. When exposed to ambient environment, the oxidizing agent may accelerate the oxidation process that disables the antenna.

### BACKGROUND OF THE INVENTION

The present invention relates to RFID (Radio Frequency IDentification) technology and more particularly to an RFID tag structure with a user-controlled kill mechanism.

The term RFID is applied to technologies that use radio waves to identify people or objects. More specifically, the people or objects are identified by attached RFID tags that are interrogated by reader devices to retrieve coded information stored in the tags.

There are different types of RFID tags. A passive RFID tag includes an antenna and an integrated circuit module for storing object identification data but has no “onboard” power source. As will be explained in more detail below, a passive RFID tag derives the power it needs to activate the integrated circuit module from radio frequency energy contained in an interrogation signal generated by a tag reader device.

An active RFID tag similarly includes an antenna and an integrated circuit module for storing object identification data but also includes an onboard battery for continually supplying power to the integrated circuit module. An active tag may continually generate an RF signal containing object identification information, whether or not the tag is currently being interrogated by an RFID tag reader.

Like an active RFID tag, a semi-passive RFID tag includes an antenna, an integrated circuit module and a battery. Like a passive RFID tag, a semi-passive RFID tag derives power from an interrogation signal and provides a response only when it is being interrogated. All of the power derived from an interrogation signal can be used in generating the tag's response to the interrogation signal because the on-board battery supplies power to the integrated circuit module.

RFID technology is considered to be a successor to barcode technology that has been used for a number of years to identify products or other objects because RFID technology has several advantages over conventional barcode technology. A barcode label must be in the line of sight of a barcode reader to recover bar code information. There is no requirement that an RFID tag be in a line of sight from an RFID reader. Moreover, an RFID tag can carry considerably more coded information than a barcode label. Finally, certain types of RFID tags can be rewritten to change the coded information stored on the tag. There is no practical way to alter a barcode label.

Because of such advantages, RFID tags are being used in ways that barcode labels cannot be used. RFID systems are being used in hospitals to track a patient's location, to track the whereabouts of costly equipment and even to control access to drugs or to “restricted access” areas in the hospital. RFID tags, in the form of tiny chips, are also being injected just under the skin of small animals, primarily cats and dogs, to carry owner contact information in case the animal is stolen or becomes lost. RFID tags are being used in traffic-monitoring systems to track individual vehicles and to electronically collect tolls “on-the-fly” from motorists who have purchased monthly passes to use toll roads.

However, the primary use of RFID tags continues to be the tracking of objects (e.g., merchandise) as those objects travel from a point of manufacture to a wholesaler's or retailer's shelves or beyond.

While manufacturers, wholesalers and retailers have responded favorably to the use of RFID tags, some consumers have been less enthusiastic about the proliferation of RFID technology. The problem is that an RFID tag does not automatically stop working simply because a consumer purchases the product to which the tag is affixed. An RFID tag can be interrogated even after a consumer is taken the purchased product home and put it into use. Consumers are uneasy because the continued readability of RFID tags, by tag readers that may be located at considerable distances from the tags, creates the potential for unscrupulous people to learn what products a consumer is using without the consumer's permission or even without the consumer's knowledge. In general, some consumers fear that RFID technology may be used in ways that amount to a breach of the consumers' expectation of privacy.

Various solutions have been proposed to address this fear. One solution requires that the seller disable or “kill” the RFID tag at the time of purchase. A problem with this solution is that there are legitimate post-purchase uses for RFID tags, including use if the consumer returns the product for servicing. Disabling the RFID tag at the point of sale prevents the tag from being used for such legitimate post-purchase uses. Moreover, disabling an RFID tag at the point of sale isn't a realistic option where the product is shipped to the consumer following an Internet or other on-line sale.

Another solution is for the consumer to take matters into his own hands by physically destroying the tag after the purchase. That may be easier said than done. Manufacturers, sellers and shippers have a vested interest in seeing that an RFID tag remains useful at least until the consumer acquires possession of the tagged product. As a result, considerable work has been done to increase the durability of RFID tags, which makes it more difficult for consumers to physically destroy them without risking damage to the product to which the tag is affixed.

What is needed is an inexpensive kill mechanism that can be easily exercised by a product consumer if and when the consumer decides the risks of preserving the RFID tag outweigh the benefits. One point at which a consumer is likely to make that decision is when the product warranty expires and the consumer is no longer likely to return the product for servicing.

### BRIEF SUMMARY OF THE INVENTION

The present invention may be implemented as an RFID transponder that includes an integrated circuit module and electrical circuitry including an antenna and conducting leads for connecting the antenna to the integrated circuit module. At least part of the electrical circuitry is fabricated from an oxidizable material. An oxidation-retardant coating overlays at least part of the electrical circuitry. The oxidation-retardant coating includes a selectable area that may be removed by a user to expose at least part of the electrical circuitry. Once the exposed electrical circuitry is sufficiently oxidized by its exposure to the ambient atmosphere, the RFID tag will cease to operate.

### BRIEF DESCRIPTION OF THE SEVERAL VIEWS OF THE DRAWINGS

FIG. 1 is a block diagram of an RFID system in which the present invention may be implemented.

FIG. 2 is a more detailed representation of one type of RFID tag in which the present invention may be implemented.

FIG. 3 is a more detailed representation of another type of RFID tag in which the present invention may be implemented.

FIG. 4 is an illustration of a typical antenna structure in an RFID tag.

FIG. 5 illustrates an RFID tag antenna in one embodiment of the present invention.

FIG. 6 illustrates part of an RFID tag in an alternate embodiment of the present invention.

FIG. 7 is a cross-section of an RFID tag according to one embodiment of the present invention.

### DETAILED DESCRIPTION OF THE INVENTION

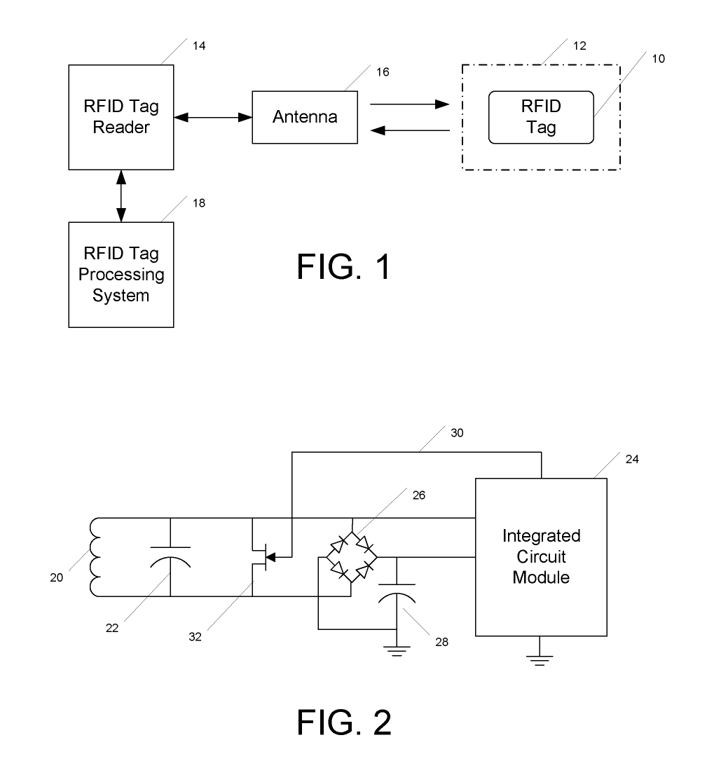

FIG. 1 shows an RFID tag 10 affixed to the surface 12 of a product or other object (not otherwise shown in the drawing). As noted earlier, the RFID tag 10 carries coded data relevant to the product or object with which it is used. As one example, if the RFID tag is being used with a consumer product, the tag may carry product information such as model number, serial number, etc. As another example, if the tag is integrated into a chip injected under the skin of a pet, the tag may carry an ID number that can be associated with contact information for the pet's owner.

The coded information stored in an RFID tag is recovered by a tag reader system that includes an RFID tag reader device 14 and an antenna 16. Where the RFID tag is passive or semi-passive, the antenna 16 broadcasts an RF interrogation signal that is received by the RFID tag. The RFID tag responds by broadcasting coded information back through the antenna 16 to the RFID tag reader 14. The acquired information is passed to an RFID tag processing system 18. What the system 18 does with the acquired information depends entirely on how the tag was intended to be used. Using one of the examples provided earlier, the RFID tag processing system may provide inventory control or shipping control information for a marketed product. Using another of the examples provided earlier, the RFID tag processing system may provide contact information for the owner of a lost pet.

FIG. 2 provides additional detail about a passive RFID tag with which the present invention may be used. A passive RFID tag includes an antenna 20 (shown with a shunt capacitor 22) that is used both to receive an RF interrogation signal from a tag reader (not shown) and to broadcast an RF response to that interrogation signal. The antenna 20 is connected to an integrated circuit module 24 that stores the coded information to be included in a generated RF response. The electrical power required to drive the integrated circuit module 24 is generated in a power circuit including a full wave diode bridge 26 and a second capacitor 28. Data to be included in an RF response to an interrogation signal is carried over a data output lead 30 to a transistor 32 that can be used to modulate an electric field generated by antenna 20.

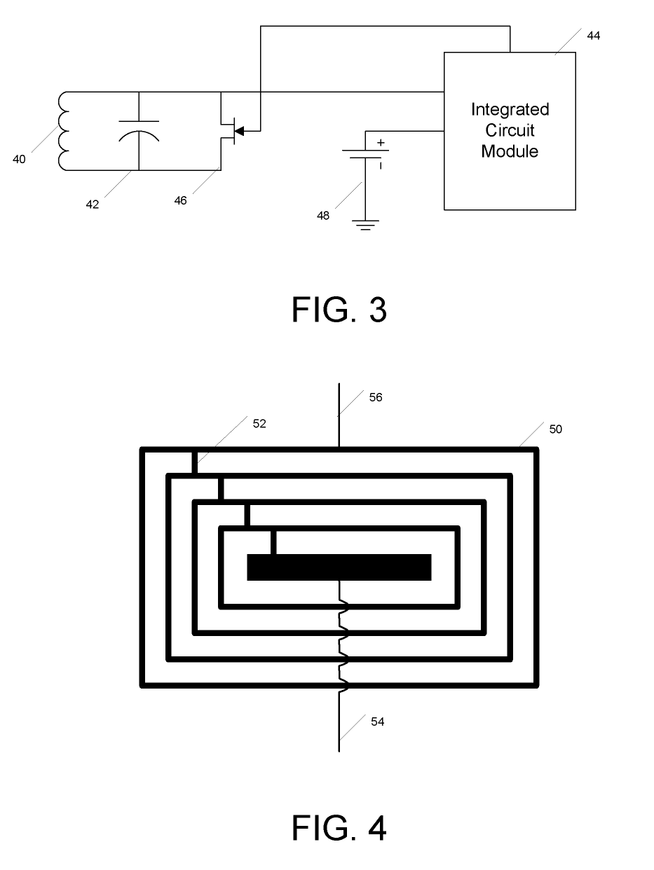

FIG. 3 shows more detail about an RFID tag implemented using either active or semi-passive RFID technology. An active or semi-passive RFID tag is similar to a passive RFID tag in that it includes an antenna 40, a shunt capacitor 42, an integrated circuit module 44 and a modulating transistor 46. The primary difference among the technologies is that an active or semi-passive RFID today does not require a full wave diode bridge since the DC power required by the integrated circuit module is supplied by an onboard battery 48.

FIG. 4 is a plan view of one known type of RFID tag antenna 50 with which the present invention may be used. The antenna 50 consists of a nested series of conductive rectangular “rings” with adjacent rings being contacted by a short conductive lead, such as the lead 52. The opposite “ends” of the antenna 50 are connected to conductive leads 54 and 56 that are used to connect the antenna to the integrated circuit module (not shown in this Figure) in the RFID tag.

Different technologies may be employed to create the antenna structure shown in FIG. 4. A traditional approach was to adhere a thin metallic foil, such as copper or aluminum, 20 to a thin PET (polyethylene terephthalate) substrate and to then use a photolithographic etching process to remove unwanted metallic foil material. A newer approach is to print the antenna using conductive inks, typically silver-based inks, and a traditional printing process. Another approach involves printing a thin conductive layer on a PET substrate and then electroplating copper onto the conductive substrate. Still another approach involves printing a catalytic ink on to the PET substrate before immersing the substrate in a solution that results in a chemical (electro-less) deposition of copper onto the printed areas.

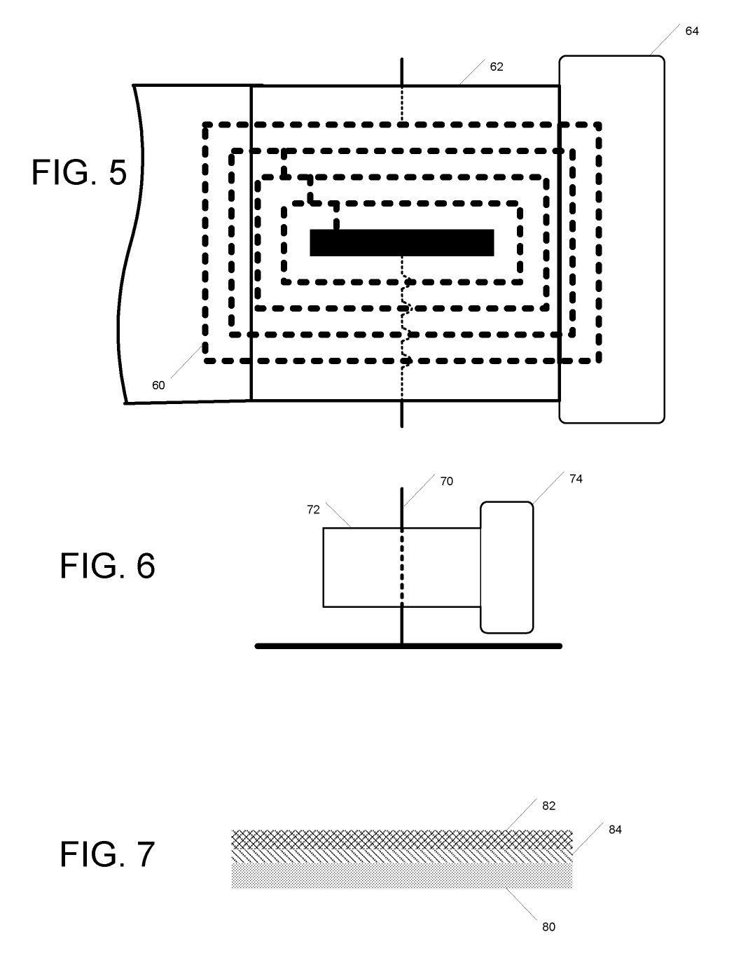

While different conductive materials and different methods of adhering those conductive materials to a substrate may be used, all of the materials (and thus any antenna fabricated using the materials) are subject to oxidation that can eventually disable the antenna. Referring to FIG. 5, oxidation of an antenna 60 can be retarded by overlaying part or all of the antenna structure with an oxidation-retardant coating 62 that protects the antenna from exposure to the ambient atmosphere.

In accordance with the present invention, at least a selectable area of the oxidation-retardant coating 62 includes a pull tab 64 that maybe readily gripped by a user who wants to remove the oxidation-retardant coating to accelerate the oxidation process that eventually will disable the antenna. While the Figure shows a selectable area that overlies only part of the antenna structure, in practice the selectable area would preferably be large enough to encompass the entire antenna structure.

In some environments, it may be desirable to protect the antenna structure by including it in a housing that is not user-accessible. In such environments, the present invention may be implemented as shown in FIG. 6 by exposing only an antenna electrical lead 70 and then covering most or all of the exposed lead with an oxidation-retarding coating 72 having a pull tab 74 that the user may grip to strip the coating 72 from the exposed lead. Once the lead 70 oxidizes, the antenna will be disconnected from the integrated circuit module, thus effectively but indirectly disabling the antenna.

Once a user has decided it is time to disable or kill the RFID tag by exposing the antenna to an oxidizing atmosphere, the user expectation will be that the RFID tag will become disabled within a relatively short period of time. Referring to FIG. 7, to help satisfy the user's expectations, a layer 84 of oxidizing agent may be deposited on the layer 80 of antenna material before the antenna is covered or overlain with an oxidation-retardant coating 82. When the coating 82 is removed by the user, the exposed oxidizing agent 84 will hasten oxidation of the antenna material to disable the antenna.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

For example, in the embodiment described in detail above, a product consumer decides when to trigger the oxidation process by stripping the oxidation-retardant coating from the RFID tag antenna. Clearly, the same RFID tag structure can be used by other parties for their own purposes.

As one example, a retailer might strip the coating from the antenna at the time of sale. Advantages of using the tag this way are that the consumer is no longer burdened with the task of removing the oxidation-retardant coating, but the tag can remain operable long enough to be useful to the retailer in processing valid product returns.

As another example, the RFID tag structure could be used to control copying and/or unauthorized use of rental movies or electronic games. The movie/game player would be coded to require a coded signal from the RFID tag as a prerequisite to executing the movie or electronic game. The RFID tag would be packaged with the rental movie or electronic game so that initial opening of the game package would strip the oxidation-retardant coating from the RFID tag, exposing the tag antenna or leads to the ambient atmosphere to begin the oxidation process. The rental movie or game would remain available for play only until the RFID tag failed due to oxidation of the tag antenna or leads. Moreover, if a counterfeiter tried to copy the rental movie or game, the copy would immediately fail since the copy process would not duplicate the RFID tag required for use of the rental movie or game.

Having thus described the invention of the present application in detail and by reference to preferred embodiments thereof, it will be apparent that modifications and variations are possible without departing from the scope of the invention defined in the appended claims.

What is claimed is:

1. An RFID transponder comprising:
an integrated circuit module;
electrical circuitry connected to said integrated circuit module, said electrical circuitry being fabricated from an oxidizable material and comprising at least an antenna and conductive leads for connecting said antenna to said integrated circuit module; and
an oxidation-retardant coating overlaying at least part of said electrical circuitry, said oxidation-retardant coating including a selectable area that may be removed by a user to expose at least a portion of said electrical circuitry.

2. An RFID transponder according to claim 1 wherein said selectable area includes a grippable pull tab.

3. An RFID transponder according to claim 2 wherein said selectable area overlies at least part of said antenna.

4. An RFID transponder according to claim 2 wherein said selectable area overlies at least part of the conductive leads for connecting said antenna to said integrated circuit module.

5. An RFID transponder according to claim 3 further comprising an oxidation-accelerating material deposited on at least that portion of said antenna overlain by said selectable area.

6. An RFID transponder according to claim for further comprising an oxidation-accelerating material deposited on a leash that portion of said conducting leads overlain by said selectable area.

7. An RFID transponder according to claim 3 further comprising a battery connected to said integrated circuit module.

8. An RFID transponder according to claim 4 further comprising a battery connected to said integrated circuit module.
